(19) United States
(12) Patent Application Publication
(10) Pub. No.: US 2018/0211318 A1
(43) Pub. Date: Jul. 26, 2018

(54) System and Method for Trading an Asset

(71) Applicants: Aniket Bharat Parikh, Scarsdale, NY (US); Archana Aniket Parikh, Scarsdale, NY (US)

(72) Inventors: Aniket Bharat Parikh, Scarsdale, NY (US); Archana Aniket Parikh, Scarsdale, NY (US)

(21) Appl. No.: 15/924,672

(22) Filed: Mar. 19, 2018

Related U.S. Application Data
(63) Continuation-in-part of application No. 14/080,012, filed on Nov. 14, 2013.
(60) Provisional application No. 61/726,716, filed on Nov. 15, 2012.

(51) Int. Cl. G06Q 40/04; G06Q 20/38

(52) U.S. Cl. CPC G06Q 40/04; G06Q 20/382

(57) ABSTRACT

Exemplary embodiments of the present disclosure are directed towards a system and method for trading an asset on a trade facilitating platform. The method comprising dividing an asset listed for trading by an owner into multiple segments ranging from a low-level risk investment segment to a high-level risk investment segment in a gradually varying risk investment level. The multiple segments of the asset are tagged with multiple digital currencies ranging from a low-level risk to a high-level risk in a gradually varying risk level. The method further includes listing the multiple digital currencies tagged with the asset by the owner for enabling multiple investors to purchase at least one digital currency among the multiple digital currencies tagged with a face value and transferring an ownership of the asset to the investors without possession of the digital asset for enabling the investors to further trade the purchased digital currencies.

### RELATED APPLICATION AND PRIORITY CLAIM

This application is a continuation-in-part of pending U.S. Non-Provisional patent application Ser. No. 14/080,012, filed on Nov. 14, 2013, which claims the benefit of priority to U.S. Provisional Patent Application No. 61/726,716, filed on Nov. 15, 2012, the contents of each of which is incorporated herein by reference in its entirety.

### TECHNICAL FIELD

The present disclosure relates to the field of systems and methods employed for facilitating online trading of assets. More particularly, the present disclosure relates to a computer-implemented method and system for trading assets by implementing block-chain driven authentication protocols. Moreover, the present disclosure relates to a method to value fungible/in-fungible assets and convert them into an electronic form which can be used to trade assets.

### BACKGROUND

Typically, purchase of assets (interchangeable assets (for e.g., gold alloy, or other similar precious, semi-precious or non-precious metal), and non-interchangeable assets (for e.g., diamonds, also include all precious gems including rubies, sapphires, emeralds as well as synthetic diamonds) and taking the physical possession of the purchased assets is widely known and is also considered as one of the investment options. Ownership of the assets is a goal held by investors, and most of the investors require financial assistance for purchasing of assets.

In an instance, the investor secures a loan against mortgage of the asset for making investments. Currently, there are several financial organizations which provide loan against the mortgage of the asset. The investor is provided with an “interest only” mortgage plan where the investor is required to merely pay the interest on the mortgage loan. However, with the payment of interest only, the purchasers may sometimes never pay down the loan and, thus, may never own the asset. Also, without gains in the value of the asset, the investor is unable to obtain equity in the asset. Yet there is a large pool of assets that many investors own but whose values are not easily converted or realized. Even if such assets are sold, the owners usually may sustain a significant drop in value compared with the original purchase price.

In the light of the aforementioned discussion, there exists a need for a certain system with novel methodologies that would overcome the above-mentioned disadvantages.

### SUMMARY

Exemplary embodiments of the present disclosure are directed towards a system and method for trading an asset.

According to an exemplary embodiment, the method includes dividing an asset listed for trading by an owner into multiple segments ranging from a low-level risk investment segment to a high-level risk investment segment in a gradually varying risk investment level. The multiple segments of the asset are tagged with multiple digital currencies ranging from a low-level risk to high-level risk in a gradually varying risk level. The method further includes listing the multiple digital currencies tagged with the asset by the owner for enabling multiple investors to purchase at least one digital currency among the multiple digital currencies tagged with a face value and transferring an ownership of the asset to the investors without possession of the digital asset for enabling the investors to further trade the purchased digital currencies.

According to another exemplary embodiment, the method further includes implementing a block-chain driven authentication or other peer-to-peer cryptocurrency systems on a trading transaction executed between an owner (e.g., a seller) and the investors (e.g., the buyers) and further recording a plurality of credentials of the trading transaction.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram representing an example environment in which aspects of the present disclosure can be implemented. Specifically, FIG. 1 depicts a schematic representation of environment for trading an asset according to an embodiment of the present disclosure.

FIG. 2 is a diagram depicting the trade facilitating platform 106 shown in FIG. 1, in accordance with one or more embodiments.

FIG. 3 is a flow diagram depicting a method for trading the asset on the trade facilitating platform, in one or more exemplary embodiments.

FIG. 4 is a flow diagram depicting a method for implementing multiple investment options on the trade facilitating platform, in one or more exemplary embodiments.

FIG. 5 is a flow diagram depicting a method for exchange of digital currencies with other digital currencies, in one or more exemplary embodiments.

FIG. 6 is a flow diagram depicting a method for calculating markup price and listing the complex asset for trading, in one or more exemplary embodiments.

FIG. 7 is a flow diagram depicting a method for trading assets using an electronic form, in one or more exemplary embodiments.

FIG. 8 is a flow diagram depicting a method for selling the asset by the owner to the investor, in one or more exemplary embodiments.

FIG. 9 is a flow diagram depicting a method for exchange the asset from a first category with the asset from a second category, in one or more exemplary embodiments.

FIG. 10 is a flow diagram depicting a method for bidding the asset by the owner to the investor on a fractional ownership basis, in one or more exemplary embodiments.

FIG. 11 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Referring to FIG. 1, FIG. 1 is a block diagram 100 representing an example environment in which aspects of the present disclosure can be implemented. Specifically, FIG. 1 depicts a schematic representation of environment for trading an asset according to an embodiment of the present disclosure. The example environment is shown containing only representative devices and systems for illustration. However, real-world environments may contain more or fewer systems or devices. FIG. 1 depicts end user devices 102a, 102b, and 102c, a network 104, and a trade facilitating platform 106. The end user devices 102a, 102b, and 102c comprise an owner's device, an investor's device or a trader's device, a manufacturer's device, a retailer's device, and the like. The end user devices 102a, 102b, and 102c may comprise a device such as a personal computer, a workstation, an electronic book reader, a personal digital assistant, a mobile phone, a computing tablet, and the like. The network 104 may include, but is not limited to, an Ethernet, a wireless local area network (WLAN), or a wide area network (WAN), a Bluetooth low energy network, a ZigBee network, a WIFI communication network e.g., the wireless high-speed internet, or a combination of networks, a cellular service such as a 4G (e.g., LTE, mobile WiMAX) or 5G cellular data service. The network 104 may provide a web interface employing transmission control protocol, hypertext transfer protocol, simple object access protocol or any other internet communication protocol. The trade facilitating platform 106 may be accessed as mobile applications, web applications, software that offers the functionality of accessing mobile applications, and viewing/processing of interactive pages, for example, are implemented in the end user devices 102a, 102b, 102c as will be apparent to one skilled in the relevant arts by reading the disclosure provided herein.

The end user devices 102a, 102b, 102c may be configured to enable users to perform trading of the assets through the trade facilitating platform 106. Here, the end users may be referred as owners, investors, creditors, traders, bidders, and the like. The buyers or purchasers or bidders may also be referred as the investors. The sellers may also be referred as owners. The users may be allowed to access the trade facilitating platform 106 by creating a user account using login identity credentials. The identity credentials comprise a unique identifier (e.g., a username, an email address, a mobile number, and the like), and a secured code (e.g., a password, a symmetric encryption key, biometric values, a passphrase, and the like). The trade facilitating platform 106 may be configured to exchange the digital currencies tagged with the segments of the asset with the assets (e.g., goods and services).

The assets may be certified by a reputed trade body or lab. The assets may include interchangeable asset (for e.g., gold alloy, or other similar precious, semi-precious or non-precious metal), non-interchangeable asset (for e.g., diamonds, also include all precious gems including rubies, sapphires, emeralds as well as synthetic diamonds), goods and services asset. The goods and services asset may include media (for e.g., TV, print, internet, and computers), travel (for e.g., airline, hotel, and car rental), accounting services, shipping services, real estate (e.g., office space, storage, and lots), food products, household goods (e.g., stoves, toasters, and lawnmowers), legal services, web design services, consulting services or any other professional services. The trade facilitating platform 106 may be populated with the assets, goods, and services. The asset listed for trading may be a single standalone asset, a subset of the asset, or a combination of one or more assets. The trade facilitating platform 106 may be configured to enable the owner to list the asset for trading and define an asking price. The asking price here may be referred as the price at which the owner is interested in selling or trading the asset on the trade facilitating platform 106. The owner may include, but is not limited to, a manufacturer, a retailer, an individual willing to trade or sell the asset, individual or firm offering goods and services, and the like. The asset listed for trading may be attached to corresponding images or videos for facilitating pictorial representation. The asset listed may be further viewed or deleted by the owner.

The trade facilitating platform 106 may be configured for enabling the owner to divide the asset listed for trading into multiple segments. The multiple segments may range from a low-level risk investment segment to a high-level risk investment segment in a gradually varying risk investment level. The segments of the asset may be tagged with an equal number of digital currencies. The digital currencies may also range from a low-level risk to a high-level risk in a gradually varying risk level. The low-level risk investment segment of the asset may be tagged with a low-level risk digital currency and the high-level risk investment segment of the asset may be tagged with a high-level risk digital currency. The segments of the asset may equal to the count of the digital currencies tagged with the asset. Furthermore, the owner may be allowed to modify the number of divided segments, modify the count of digital currencies accordingly, and also modify the asking price accordingly. The segments of the asset listed for trading may be blocked (in whole or in part) from further trading making the asset non-interchangeable with another listed for trading on the trade facilitating platform 106. The count of the segments of the asset may be higher and/or lower to the variable count of the digital currencies tagged with the asset. For, e.g., If 1 ct=100 cents=value $2500, then initially each digital currency carries 2500/100=2.5 cents of weight. If 10% value falls, then the top 10% of the “high risk” investors are wiped out. So, either the value of the Ct. Field of the digital currency may show “0” or its $ value. The digital currency remains an empty shell remembering what it used to weigh. The weight is passed onto the other lower risk investors to keep the value of their currencies intact. But then they become the next high-risk investors. If the price increases, the weights go upwards in proportion to the percentage % risk asset or the value field changes reflecting price movement.

The trade facilitating platform 106 may be configured to define a PEG price for the asset listed for trading by the owner. The PEG price may also be referred as a benchmark price. The PEG price of the asset may be configured to be dynamically changing in response to a predetermined chart. The PEG price may further comprise a static value. The trade facilitating platform 106 may be configured to determine the PEG price of the asset, based on the predetermined chart. The trade facilitating platform 106 may get the data from outside servers or data providers online etc. or actual trades happening on the platform or a combo of all. In an example, for diamonds, say D/SI1, based on the market knowledge, market statistics, history of the product, future outlook value of lower qualities of same or similar types etc., D/SI1 is priced at a price per one carat (e.g., $6000/1 carat). This may be referred as the “starting” PEG price. From this point forward, each of the categories of assets (e.g., the D/SI1) may start gaining a “DYNAMIC” PEG price based on the predefined charts which are driven by multiple parameters. As the chart parameters change over time, the dynamic price also changes. For exchangeable products such as gold, the charting system only looks at caratage of the product, and/or the current market price of the product. However, for non-exchangeable products such as Diamonds, the trade facilitating platform 106 may come up with a chart that may be included different type of factors/parameters (for e.g., different minute differences in the characteristics of the similar type of stones) (for e.g., wars, macroeconomic factors). The trade facilitating platform 106 may be further configured to transfer an ownership of the asset listed for trading to the investors without possession of the digital asset for enabling the investors to further trade the purchased digital currencies. E.g., the trade facilitating platform 106 is configured to transfer the ownership through an attached “ownership” currency locked to the other digital currency which may be locked if the user does not want to give physical possession or if in case of a sale of an asset that may be returned by the user or may be returned at a later date in case user doesn't like it and the user re-sells the currency and waits for the final transaction to occur at a final date creating a hold on the transactions till acknowledgement of the actual sale refer to “Parikh” process. The Parikh process includes, in a first embodiment, an asset is sold at the negotiation of the asking price or the PEG price. In an example, if an owner is willing to sell the asset (e.g., a jewellery) at the asking price or the PEG price (e.g., 100 terra coins). An investor is willing to buy it for less than the asking price or the PEG price (e.g., 80 terra coins). Then the possibilities are, either the owner agrees for negotiations and sells the jewellery at PEG price of 80 terra coins or decides not to sell the jewellery.

In a second embodiment, an exchange of the asset from a first category with the asset from a second category for the price equal the PEG price of the asset from the first category, the price equal to the asking price of the asset from the first category, the price equal the PEG price of the asset from the second category, the price equal to the asking price of the asset from the second category. In an example, if the owner is willing to sell the asset from the first category (e.g., the jewellery) at the asking price or the PEG price (e.g., 100 terra coins). The investor is willing to buy it but instead of paying the asking price or the PEG price (e.g., 100 terra coins), the investor may exchange it with the asset from the second category (e.g., a land) which also worth value is equal to the asking price or the PEG price (e.g., 100 terra coins), if agreed by the owner.

In a third embodiment, the exchange of asset from the first category with the asset from the second category for the price greater than PEG price of the asset from the first category, the price higher than the asking price of the asset from the first category, the price greater than PEG price of the asset from the second category, and the price higher than the asking price of the asset from the second category. In an example, if the owner is willing to sell the asset from the first category (e.g., the jewellery) at the asking price or the PEG price (e.g., 100 terra coins). The investor wants to exchange it with the asset from the second category (e.g., a car) of worth value is greater than the asking price or the PEG price (e.g., 300 terra coins), then the owner gives the asset from the first category (e.g., the jewellery) to the investor and the owner pay remaining digital currency (e.g., 200 terra coins) for the asset from the first category (e.g., the jewellery), if agreed by the owner.

In a fourth embodiment, the exchange of asset from the first category with the asset from the second category for the price lower than PEG price of the asset from the first category, the price lower than the asking price of the asset from the first category, the price lower than PEG price of the asset from the second category, and the price lower than the asking price of the asset from the second category. In an example, if the owner is willing to sell the asset from the first category (e.g., the jewellery) at the asking price or the PEG price (e.g., 100 terra coins). The investor wants to exchange it with the asset from the second category (e.g., the jewellery) of worth value is less than the asking price or the PEG price (e.g., 50 terra coins), then the owner gives the asset from the first category (e.g., the jewellery) to the investor and the investor pay remaining digital currency (e.g., 50 terra coins) for the asset from the first category (e.g., the jewellery), if agreed by the owner.

In a fifth embodiment, the trade facilitating platform 106 may further comprise a collective bidding mechanism. The trade facilitating platform 106 may be configured to allow multiple bidders (e.g., a first bidder, a second bidder, a third bidder and a fourth bidder) to bid for the asset. Here, the bidder may also be referred as the investor. A bidder may bid for a fractional ownership of the asset and the collective bid of comparable or varying values, of one or more bidders, in entire or part may either be accepted or rejected by the owner where the accepted bids maybe lower than the highest bids, if they don't match the bid criteria set by the owner or the investor. E.g., time based bidding-where there possibly a holding time for the actual sale to be verified. For example, in case of a purchase of the asset from the first category (e.g., the shirt) in exchange for the asset from the second category (e.g., a gemstone) and there is a return policy of days (e.g., 30 days) may not match a wait time acceptance of a lower bid. A further cost to either or all parties may be included independently for hold time. The owner may see the aggregate offer sum which may be lesser, equivalent or higher than the actual or PEG price of the asset or the highest bid price based on a bid criteria. For example, if the owner sells the asset from the first category (e.g., the jewellery) at the asking price or the PEG price (e.g., 100 terra coins) and if there are bidders (e.g., four bidders) bidding at the rate of terra coins (for e.g., 10, 20, 30 and 40 terra coins respectively). The owner may choose to accept the bid in which case, each of the bidder may get a fractional ownership of the asset as percentages (e.g., 10%, 20%, 30% and 40% percentages) at the same or varying bid prices respectively. Also, in case the owner wants to keep the bid price private then the owner may allow to do it on the trade facilitating platform 106. The bidder who has got fractional ownership of the asset is free to sell or hold on to the asset. In another embodiment, if the owner sells the asset from the first category (e.g., the jewellery) at the asking price or the PEG price (e.g., 100 terra coins) and if bidders are bidding at a rate of terra coins (e.g., 10, 20, 30 and 20 terra coins respectively). It's the choice of the owner whether to accept or reject the bid for a lower price (e.g., 80 terra coins) than the PEG price. The trade facilitating platform 106 may comprise a reserve price mechanism for bidding.

The trade facilitating platform 106 may provide a possibility of having spot and deferred delivery and the view of accessibility of the asset class. For instance, if the asset from the first category (e.g., the jewellery) is not prepared and may be delivered in some days (e.g., 15 days) the owner may demonstrate the same and the investor is allowed to choose whether he is interested in the same. In addition to this, there is a possibility for the investor who has focused on buying the asset at a future date to exit by paying a premium for the same.

Likewise, if the owner sells the asset from the first category (e.g., the jewellery) at the asking price or the PEG price (e.g., 100 terra coins) and if the owner wants to exchange the asset from the first category (e.g., the jewellery) with the asset from the second category (e.g., the land). The owner (e.g., the land owner) may accept the asset from the first category owner price and in the meantime get offers from the bidders and re-pitch the asset from the first category (e.g., the jewellery) to the investor himself, while keeping the offer price of the asset from the second category (e.g., the land) unaltered and offer price of the asset from the first category (e.g., the jewellery) higher or lower based on bids from the investors. Also, the owner or the investor may keep the bid price as private information from others if needed. In this way two exchanges may be completed at the same time. The trade facilitating platform 106 may be configured to make the derivatives contracts or exchange contracts or future contracts. The trade facilitating platform 106 may also be configured to promote the asset as a set or subset or super set or a universe of each or all the asset classes and sold or listed or transacted as individual or part.

The digital currencies may further comprise non-asset tagged digital currencies. The trade facilitating platform 106 may be configured to implement a block-chain driven authentication on a trading transaction executed between the owners and the investors. The trade facilitating platform 106 may be configured to record the credentials of the trading transaction.

For an example, if the asset is a diamond (e.g., D/SI1), the diamond (e.g., D/SI1) is named as an asset#1 on the trade facilitating platform 106. The asking price of the asset#1 (e.g., $7000) is provided by the owner. The trade facilitating platform 106 may be reserve the asset#1 at the price (e.g., $6000). The owner has two choices, the first choice which is the owner leaves the asset#1 on the trade facilitating platform 106 listed at the asking price (e.g., at 7 k) and simply waits for someone to buy it at that price, after which the asset#1 is delivered to the purchaser. The second choice which involves a digital currency. The owner deposits X % of the reserve into the escrow account managed by the trade facilitating platform 106. For an example, 5% of the reserve price, the trade facilitating platform 106 then issues or releases the digital currency for the asking price. The trade facilitating platform 106 may be configured to take the full digital currency (e.g., coins up front, or simply issue them and collect the payment (minus the commission) on the sale of the coins). For an example, if a particular asset is divided into some units (e.g., 100 units) of risk starting from the low risk to the high-risk, there may be different digital currencies (e.g., 100 digital currencies) issued for this particular asset. The level 1 of the digital currency representing the lowest risk and the level 100 of the digital currency representing the highest risk for a particular asset. The owner then makes the digital currency (e.g., 100 digital currency coins) available for trading on the trade facilitating platform 106.

The trade facilitating platform 106 may be configured to provide multiple investment options. For example, in the first type of investment option, the investor may pay or purchase for the asset in part or full using the cash (e.g., rupees, dollars, euros, pounds) or digital currency or cryptocurrency or bitcoins or terra coins and with part or full ownership title etc. and take the possession of the asset at a certain price and continue listing the portion on the trade facilitating platform 106 while making use of the physical asset giving option to see the value of purchase in real time and exit when needed easily. In the second type of investment option, the investor may purchase the asset at certain price without possession and further list the purchased asset for trading. The purchasing price may be lower than the PEG price, equal to the PEG price, greater than the PEG price, lower than the asking price, equal to the asking price, higher than the asking price. In the third type of investment option, the investor may purchase the digital currencies in exchange for currency. For example, the investor may simply pay $x to receive the same $x in the digital currency. The fourth type of investment option may be allowing the owner listing the asset for trading to purchase the digital currency for the asking price of the asset and further purchase goods and services offered in the trade facilitating platform 106. The trade facilitating platform 106 may be configured to enable the investors to purchase the digital currencies tagged with a face value. The face value is the nominal value or digital currency value of the asset stated by the owner. The investors may be enabled to view the risk-level associated with the digital currencies for purchasing the digital currency on the trade facilitating platform 106. The trade facilitating platform 106 may be configured to exchange the digital currencies tagged with the face value of one asset with other digital currencies tagged with the face value of another asset. The exchange of the digital currencies may be executed in response to calculating the count of the digital currencies tagged with the face value of one asset required to exchange with other digital currencies tagged with the face value of another asset. The face value of each digital currency among the digital currencies is defined (a) by dividing the asking price with the digital currencies tagged with the asset, (b) based on the predetermined chart. The exchange of the digital currencies is defined (a) by dividing the count of the digital currencies tagged with the face value of one asset required to exchange with other digital currencies tagged with the face value of another asset, (b) based on the predetermined chart. The digital currencies tagged with other values, i.e., the actual current value traded in current time or even the asking value e.g. a shirt owner may be willing to accept to pay more than the current market value for the digital currency to sell the shirt where the shirt owner is able to absorb the losses because of high profit margins if he sells the digital currency back on the market. The trade facilitating platform 106 may be configured to allow interchange or transfer of sale or purchase of the asset into it for coins of similar type of asset based on the PEG price. If there is non-interchangeable asset, the exact difference in quality grade is not known, the value above the PEG value may be expressed or transferred as a high-level risk coin (an unknown) and valuation below the PEG price as low risk. As users know how to value a specific asset, the price may be found.

For an example, the investors start buying the digital currencies (level 1-100) based on the amount of risk they are willing to accept on the trade facilitating platform 106. Each of the digital currency (e.g., “TERRACOINS”) may be valued at 1/100th of the total asking price of the asset. For a value of the asset (e.g., 7K), each digital currency (e.g., each TERRACOIN) may have a price (e.g., $70), i.e., the face value of the digital currency (e.g., the TERRACOIN). The investor investing on the Asset #1's Level 1 digital currency (e.g., coin) (A1C1L1) is willing to put down the price (e.g., $14) on top of the price (e.g., $70) to purchase that digital currency (e.g., the coin). The investor willing to invest in A1C100L100 may only be willing to invest the amount (e.g., $0.70) over the top of amount (e.g., $70 value). All the investments may obviously go under-par or over-par. The owner may get to resell all the assets (e.g., 100 coins) at whatever price the market is willing to buy it at the trade facilitating platform 106. The owner may make money or lose money on doing the exercise.

On each sale (e.g., the original sale, the follow-on trades, and on the final sale) of the assets, the trade facilitating platform 106 may be configured to make a percentage. After all initial assets (e.g., 100 coins) are sold, the owner technically is not the owner anymore, and there may include new 100 owners. The owner needs to give up the physical possession of the asset and the trade facilitating platform 106 returns the escrow amount (e.g., some percentage) to the escrow account. The investors of the digital currency (e.g., 100 coins) may drive the price up and down on the trade facilitating platform 106 by trading amongst themselves. The face value of the digital currency (e.g., the coin) may always remain the 1/100th value of the original asking price of the owner. Thereafter the value of the digital currency (e.g., the coin) may go up and down but the face value may not change. Once the trade facilitating platform 106 decides to sell the physical asset at some point in the future, the point may be based off %+/−the PEG price or based off actual demand of the user, the individual investors (for e.g., 100 investors) may get the face value back (if the exchange is able to sell the asset at the face value) and some more (if there is a profit or loss over the face value). The face value part of the sale price may be divided equally among the digital currencies (e.g., 100 coins), the profit part of it is not equally divided and is shared proportionally among the digital currency holders (e.g., coin holders) with the digital currency holder (e.g., L100) receiving more of the proportion of the profit than the currency holder (e.g., L99). The digital currency (e.g., the coins) with the face value (e.g., A1C20L20) may be exchanged with “exchange-level-assets” that is valued at the one digital currency (e.g., 1 cent) each. For example, if the digital currency (e.g., a coin) is face-valued at the price (e.g., $50), the investor may exchange that asset price (e.g., $50) with the amount of the digital currency (e.g., 5000 1 cent coins). The digital currency may be used on the trade facilitating platform 106, including being sold as segments of that particular asset to the investors. Since the digital currency (e.g., the coins) is always tagged with the asset, they may always be referred or called back and replaced with the digital currency (e.g., “vanilla” coins) that may not be tagged to any asset but are still usable for trading on the trade facilitating platform 106. Each of the digital currency may hold the original asset information attached to the trade facilitating platform 106. The asset information may include but is not limited to, original asset weight, caratage, and other criteria based on one or multiple or nature or type of assets, and the like.

For the complex assets (combination of interchangeable asset, non-interchangeable, and external price), e.g., a simple jewelry with a diamond on a gold ring, there may include a cost of the diamond, a cost of the gold ring, and external price which includes cost of acquisition, labor and credit amounts and profit amount (which is jewelry sold on credit)-all together called a markup. The interchangeable or non-interchangeable assets may include e.g. the markup of its own amounts. The digital currency (e.g., coins) may be issued against each individual parameter of the markup price as well as the actual jewelry itself and the markup asset may also be traded as an individual part or as a whole of the complex asset or combo of both. The trade facilitating platform 106 may be configured to create charts for the complex asset (e.g., jewelry). The created charts may include but are not limited to, labor charts, credit charts (with a credit risk), and the like. The digital currency (e.g., the coins) may be used to buy, exchange goods and services. The trading of the digital currency (e.g., coins) across various assets may also be performed.

The trade facilitating platform 106 may be configured to split an in fungible asset into a fungible and non-fungible segment(s). The fungible part being of a stable value, while in fungible being of a more volatile or fluctuating value. The fungible and non-fungible segment(s) may be translated into an electronic form and traded on the trade facilitating platform 106. The split values may be derived based on one or multiple or nature or type of assets. Where e.g. in diamonds, the 4C's are the general principles, i.e. carat (weight), clarity (transparency), color, and cut. The cut and carat (weight) are able to be determined more accurately than the color and clarity. Machines exist for grading cut, carat, color that makes them more determinable and fungible. The diamonds are split into certain groups or categories based on these 4C's have given an approximate valuation table. But the main issue of clarity interchangeability and to a lower level, the color still persist. These groupings are used by size, carat (weight), clarity (transparency), color, and cut grades (more categories may be added) to split the known values and unknown values or generally accepted principles of that asset.

| 1ct | si1 | si2 | si3 | i1 | excellent cut |
|---|---|---|---|---|---|
| G | 4600 | 3800 | 3425 | 2700 | |
| H | 4200 | 3630 | 3175 | 2600 | |

For e.g., if the grouping says that a 1 ct diamond of G color SI2 with an excellent cut is worth $3800 and an H color SI2 is worth $3600 then a 1 ct diamond of G color si2 clarity and excellent cut grade may be split up in 2 or more segments. First of $170 (3800-3630) and then to a lower quality $205 (3630-3425) and then further into lower color as well as lower clarity $250 (3425-3175 & so on). ((an arbitrary split may also be used like a 30-70 ratio taking into consideration the next generally accepted lower/or higher) values or even 1-100 segments each having a tier-based value if needed where the top is most volatile and the lowest is the least). The user may feel happy to pay or accept the asset of greater or better value for a lesser value on a general basis. But if one is very picky and wants exactly the same exact asset like a Mona Lisa of which there is just one then certain limitations may occur or some failsafe based on the assets generally accepted principles may need to be used. The user is allowed to either decide if they want the 30% first that may lock in an actual physical asset of exact liking to the choice or/and it gives a “safety net” for people who invest in the 70% or stable value of the gem who may wish to wait for the prices of the 30% to drop and then later buy the gem of their exact choice.

Most of the assets are fungible, e.g. the weight and size and cut proportions of the gem, the clarity is the main culprit, split the values up and allow e.g. the 30% split to remain as “in fungible” and the 70% as a known/interchangeable/stable value. The values are locked or based off any number of charts or indices, etc. that may be generally accepted and created for this purpose. The index or chart may be changed in either real-time or weekly basis etc. depending on trades and data generated and as the prices change and/or a basic starting point may be created like a stock market index that has a start date and continues to graph the values based on the physical attributes etc. of the gem etc. As the values change, the 2 or more splits may act in unison or separate ways: a cell X-30%, and a cell Y-70%.

The cell X-30% may be the attribute that is unknown and or not fully fungible and may be linked to the physical asset. E.g. clarity grade, Profit on sale, persons time or labor involved, rarity of asset (one of a kind or few in the world) etc. Where the asset is a composite of 1 or more types of assets (e.g. a jewelry with gold diamonds and colored stones)/costs/illusions (perceived value) etc. The cell X may be broken up into many cells all having a link to the whole asset. And each traded separately if needed or as a block based on the type of cell. The cell X may be traded based on the asset and bought and sold and prices may be based off this asset and its transactions when someone wants ownership of the actual physical asset.

The Cell Y-70% may be the attribute that is known and fully or more easily fungible and may be linked to a physical asset. The Cell Y may be allowed to do the following: As the values change based on the index etc., the Cell Y may derive value from the Cell X to remain” full” or “at the original value”. Or give up the extra weight value or density that it has gained due to a price increase and pass onto the cell X the extra value or split into a smaller part or carry the extra weight and may bump other molecules or parameters up or down the index when the weight value or density increases enough.

An electronic currency exchange form (e.g. terra bits or terra bytes) or “Units of exchange” (UOE) may be determined by the value of the assets and their splits into the Cell X-30%, and the Cell Y-70%. These may be either denominated into huge blocks or into the smallest denominated values of the currency e.g. local currency allowing ease of exchange and act as a medium of exchange between the users and assets exchanged. The data may hold for the original asset and or multiple assets inside it. All the information that is needed e.g. who owns it, who is previous owner and prices exchanged etc. basically the complete block chain may be created if needed. Any profit or loss or interest received or etc. may be equally transmitted to these cells or deducted as maybe the case. Then the cells do the needful as per the instructions or nature.

The Units of exchange” (UOE) may be bought and sold or used to displace other UOE based on the strength/density/value. The user may buy or sell any of the cells or trade them for goods and services and later buy back the cells after repaying in cash or another accepted medium.

When an asset leaves the trade facilitating platform 106 completely, the cells corresponding to that asset is removed with it and replaced with other cells of same nature or a reserve phantom UOE or a cash equivalent etc.

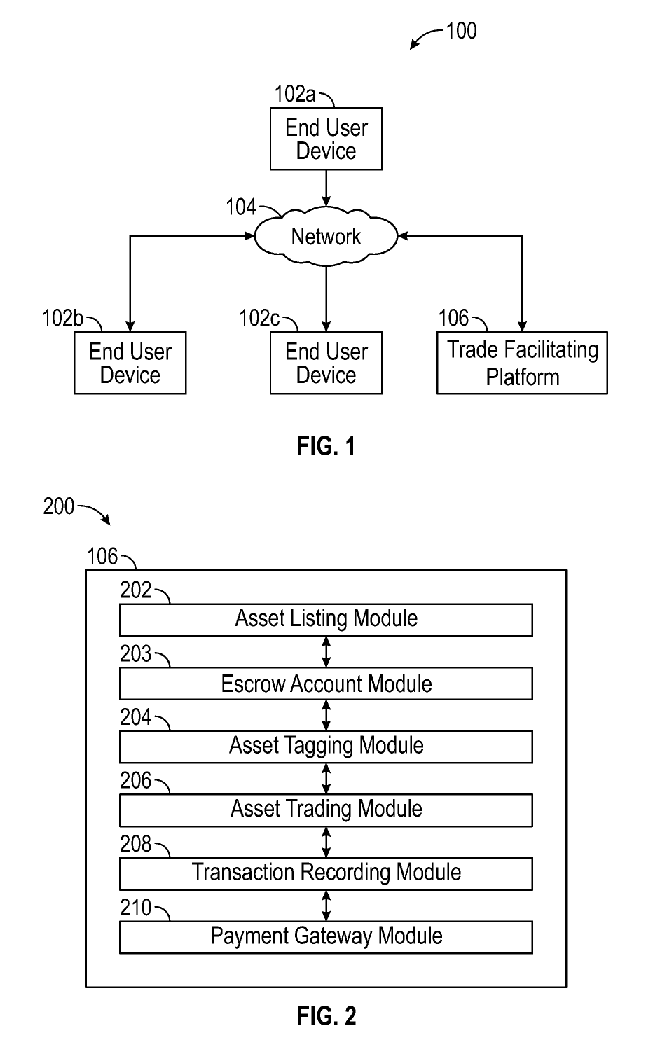

Referring to FIG. 2, FIG. 2 is a diagram 200 depicting the trade facilitating platform 106 shown in FIG. 1, in accordance with one or more embodiments. The trade facilitating platform 106 comprises an asset listing module 202, an escrow account module 203 an asset tagging module 204, and an asset trading module 206, a transaction recording module 208, and a payment gateway module 210.

The asset listing module 202 is configured for enabling an owner to list an asset and divide the asset into multiple segments ranging from a low-level risk investment segment to a high-level risk investment segment in a gradually varying risk investment level. The escrow account module 203 may be configured for enabling the owner to deposit a predetermined reserve currency for listing the asset in the asset listing module 202. The escrow account module 203 may be further configured for enabling the investors to deposit a predetermined reserve currency or an asset etc. as collateral for trading the digital currencies. The asset tagging module 204 may be configured to dynamically tag or user-defined the segments with digital currencies ranging from a low-level risk to high-level risk in a gradually increasing risk level. The low-level risk investment segment tagged with a low-level risk digital currency and high-level risk investment segment tagged with a high-level risk digital currency. The asset trading module 206 may be configured for enabling an owner to list the digital currencies tagged with the asset for trading and for enabling investors to purchase the digital currency among the digital currencies tagged with the face value. The investors may be enabled to view the risk-level associated with the digital currencies for purchasing the digital currency. The transaction recording module 208 may be configured for authenticating a trading transaction executed between owners and the investors and further record the credentials of the trading transaction.

The trade facilitating platform 106 may be configured with a payment gateway module 210 for allowing the owners and investors to deposit amount to the registered account and the escrow account, to purchase the digital currencies and exchange the digital currencies. The payment options may include, but not limited to, a digital wallet, NEFT/RTGS/IMPS transfers, payment through credit or debit card. The trade facilitating platform 106 may be configured to enable the printable format that has a bar code or machine readable QR code which may be used to transfer funds based on that printed code.

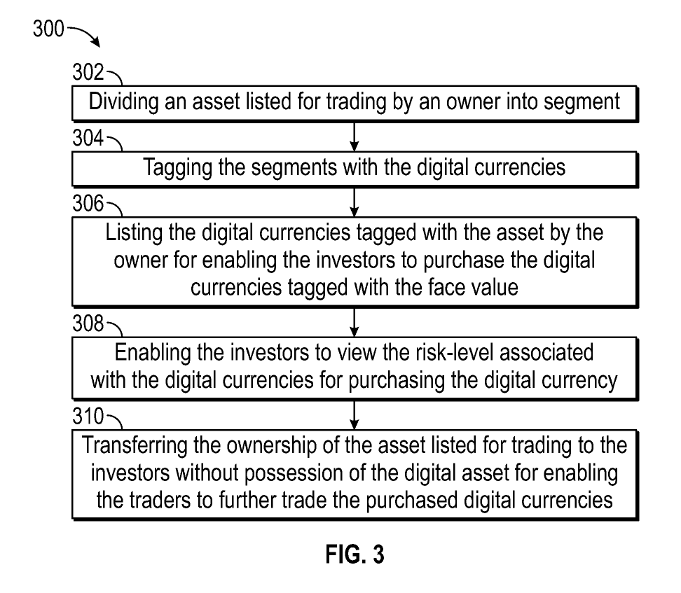

Referring to FIG. 3, FIG. 3 is a flow diagram 300 depicting a method for trading the asset on the trade facilitating platform, in one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, by dividing the asset listed for trading by the owner into multiple segments. Thereafter, at step 304, tagging the segments with the digital currencies is done. Here, the count of the multiple segments is equal to the risk percentage associated with each segment and the count may also be denoted by the number of currencies attached to the segments. Thereafter, at step 306, listing the digital currencies tagged with the asset by the owner for enabling the investors to purchase the digital currencies tagged with the face value. Thereafter, at step 308, enabling the investors to view the risk-level associated with the digital currencies for purchasing the digital currency. Thereafter, at step 310, transferring the ownership of the asset listed for trading to the investors without possession of the digital asset for enabling the traders to further trade the purchased digital currencies.

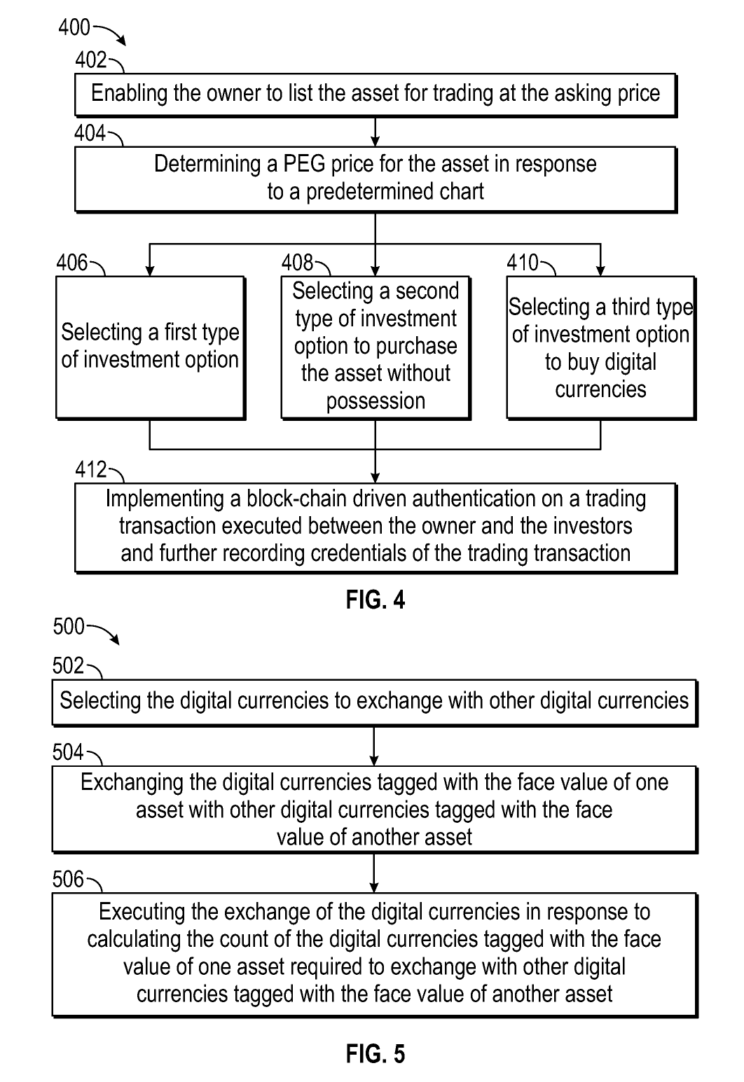

Referring to FIG. 4, FIG. 4 is a flow diagram 400 depicting a method for implementing a block-chain driven authentication on a trading transaction executed between the owner and the investors, in one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling the owner to list the asset for trading at the asking price. Thereafter, at step 404, determining the PEG price for the asset in response to a predetermined chart. Thereafter, at step 406, selecting the first type of investment option. Thereafter, at step 408, selecting the second type of investment option to purchase the asset without possession. Thereafter, at step 410, selecting the third type of investment option to buy digital currencies. Thereafter, at step 412, implementing the block-chain driven authentication on a trading transaction executed between the owner and the investors and further recording credentials of the trading transaction.

Referring to FIG. 5, FIG. 5 is a flow diagram 500 depicting a method for exchange of digital currencies with other digital currencies, in one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, selecting the digital currencies to exchange with other digital currencies. Thereafter, at step 504, exchanging the digital currencies tagged with the face value of one asset with other digital currencies tagged with the face value of another asset. Thereafter, at step 506, executing the exchange of the digital currencies in response to calculating the count of the digital currencies tagged with the face value of one asset required to exchange with other digital currencies tagged with the face value of another asset. For an example, if the digital currency tagged with one asset is face-valued at the price $100, the investor may exchange the asset with one or more number of digital currencies whose combined value is equal to the $100.

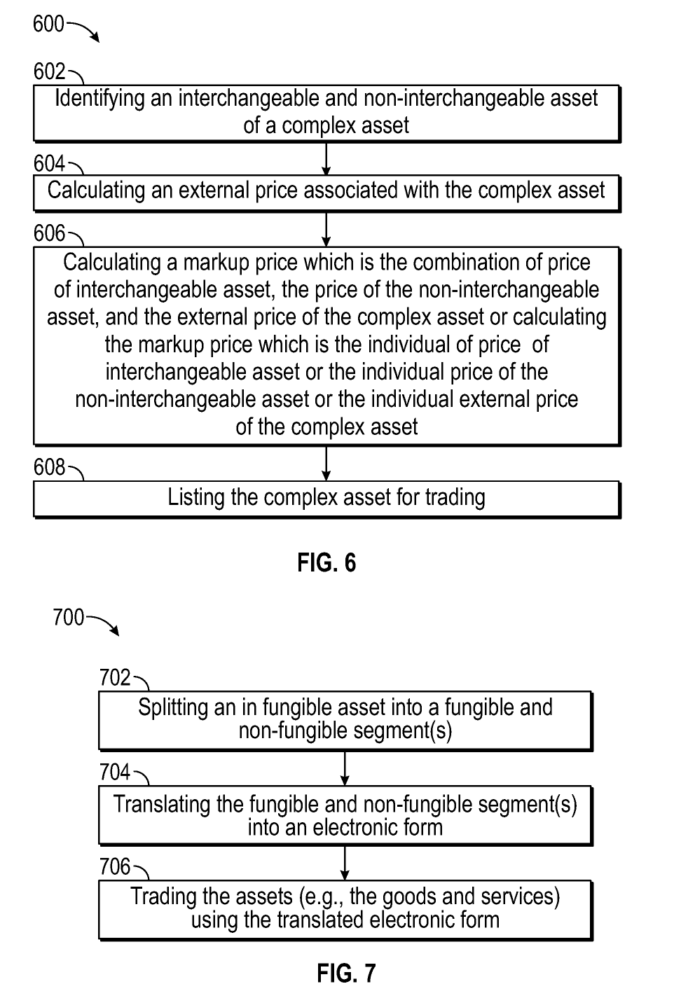

Referring to FIG. 6, FIG. 6 is a flow diagram 600 depicting a method for calculating the markup price and listing the complex asset for trading, in one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, identifying the interchangeable and non-interchangeable asset of a complex asset. Thereafter, at step 604, calculating an external price associated with the complex asset. At step 606, the markup price of the complex asset is calculated which is the combination of the price of interchangeable asset, the price of the non-interchangeable asset, and the external price or the markup price of the complex asset is calculated which is the individual price of interchangeable asset or the individual price of the non-interchangeable asset, or the individual external price. Thereafter, at step 608, the complex asset may be listed for trading.

Referring to FIG. 7, FIG. 7 is a flow diagram 700 depicting a method for trading assets using the electronic form, in one or more exemplary embodiments. The method 700 may be carried out in the context of the details of FIG. 1, FIG. 2, FIG. 3, FIG. 4, FIG. 5, and FIG. 6. However, the method 700 may also be carried out in any desired environment. Further, the aforementioned definitions may equally apply to the description below.

The method commences at step 702, splitting an in fungible asset into a fungible and non-fungible segment(s). Thereafter, at step 704, translating the fungible and non-fungible segment(s) into the electronic form. Thereafter, at step 706, trading the assets (here assets are referred to goods and services) using the translated electronic form.

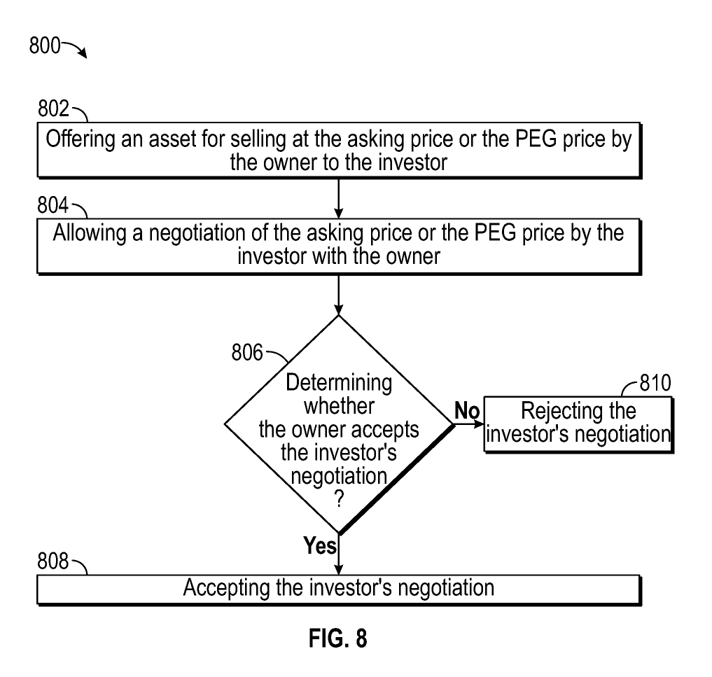

Referring to FIG. 8, FIG. 8 is a flow diagram 800 depicting a method for selling the asset by the owner to the investor, in one or more exemplary embodiments. The method 700 may be carried out in the context of the details of FIG. 1, FIG. 2, FIG. 3, FIG. 4, FIG. 5, FIG. 6, and FIG. 7. However, the method 800 may also be carried out in any desired environment. Further, the aforementioned definitions may equally apply to the description below.

The method commences at step 802, offering the asset for selling at the asking price or PEG price by the owner to the investor. Thereafter, at step 804, allowing the negotiation of the asking price or the PEG price by the investor with the owner. Thereafter, at step 806, determining whether the owner accepts the investor's negotiation. If the answer to step 806 is YES, then at step 808, accepting the investor's negotiation. If the answer to step 806 is NO, then at step 810, rejecting the investor's negotiation.

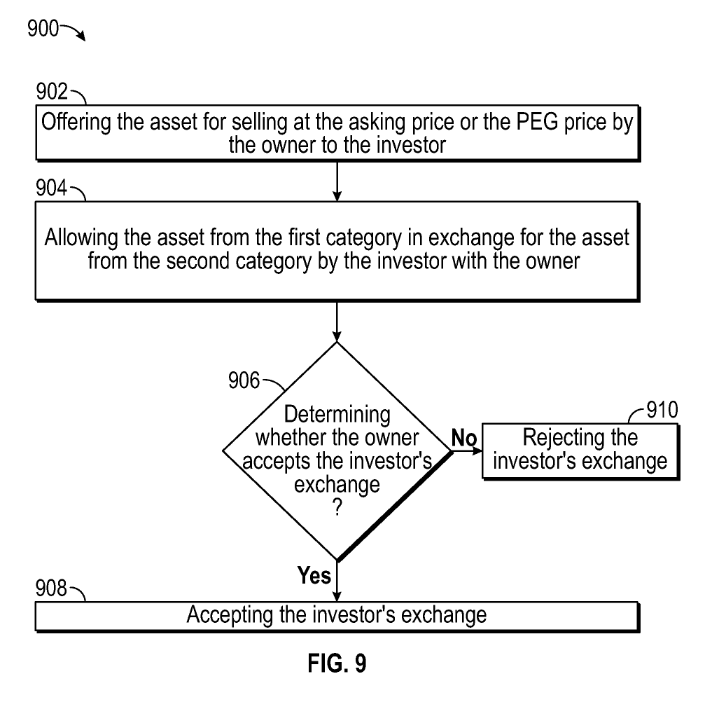

Referring to FIG. 9, FIG. 9 is a flow diagram 900 depicting a method for exchange the asset from the first category with the asset from the second category, in one or more exemplary embodiments. The method 900 may be carried out in the context of the details of FIG. 1, FIG. 2, FIG. 3, FIG. 4, FIG. 5, FIG. 6, FIG. 7, and FIG. 8. However, the method 900 may also be carried out in any desired environment. Further, the aforementioned definitions may equally apply to the description below.

The method commences at step 902, offering the asset for selling at the asking price or the PEG price by the owner to the investor. Thereafter, at step 904, allowing the exchange of asset from the first category with the asset from the second category by the investor with the owner. Thereafter, at step 906, determining whether the owner accepts the investor's exchange. If the answer to step 906 is YES, then at step 908, accepting the investor's exchange. If the answer to step 906 is NO, then at step 910, rejecting the investor's exchange.

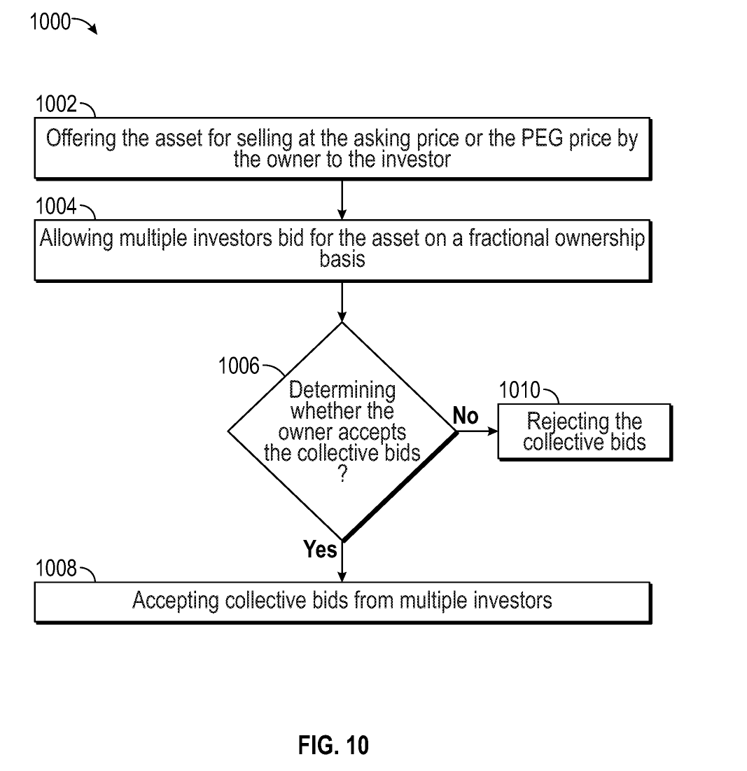

Referring to FIG. 10, FIG. 10 is a flow diagram 1000 depicting a method for bidding the asset by the owner to the investor, in one or more exemplary embodiments. The method 1000 may be carried out in the context of the details of FIG. 1, FIG. 2, FIG. 3, FIG. 4, FIG. 5, FIG. 6, FIG. 7, FIG. 8, and FIG. 9. However, the method 1000 may also be carried out in any desired environment. Further, the aforementioned definitions may equally apply to the description below.

The method commences at step 1002, offering the asset for selling at the asking price or the PEG price by the owner to the investor. Thereafter, at step 1004, allowing multiple investors bid for the asset on a fractional ownership basis. Here, the multiple investors may also be referred as multiple bidders. Thereafter, at step 1006, determining whether the owner accepts the collective bids (with the option of doing so in whole/full or in part, according to one embodiment). If answer to step 1006 is YES, then at step 1008, accepting collective bids from the multiple investors (e.g., the bidders). If answer to step 1006 is NO, then at step 1010, rejecting the collective bids (with the option of doing so in whole/full or in part).

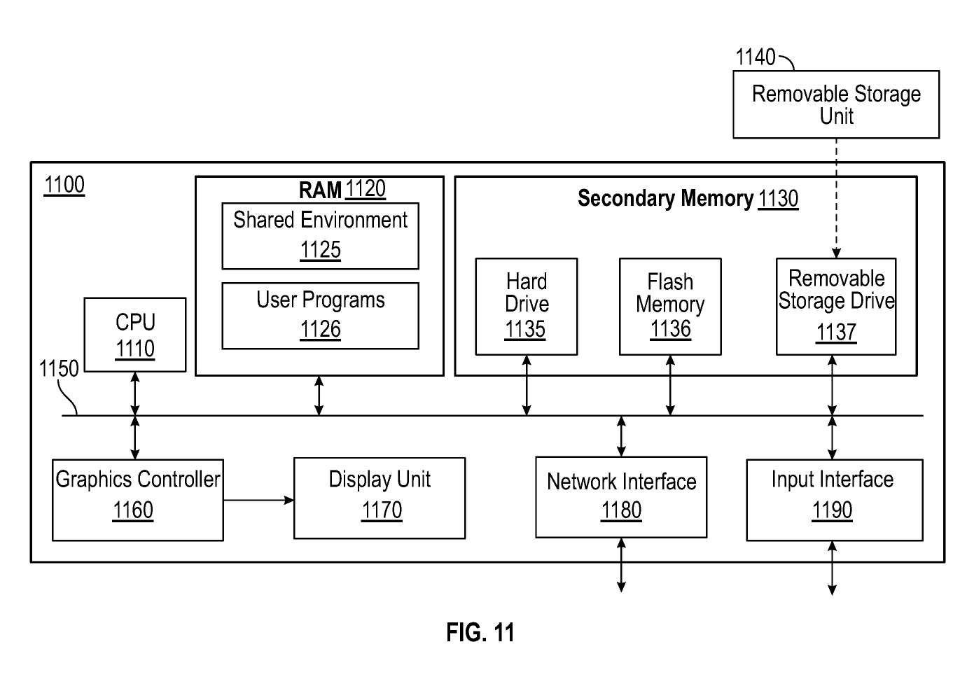

Referring to FIG. 11, FIG. 11 is a block diagram illustrating the details of digital processing system 1100 in which various aspects of the present disclosure are operative by execution of appropriate software instructions. Digital processing system 1100 may correspond to the end user device 102a, 102b, and 102c (or any other system in which the various features disclosed above can be implemented).

Digital processing system 1100 may contain one or more processors such as a central processing unit (CPU) 1110, random access memory (RAM) 1120, secondary memory 1127, graphics controller 1160, display unit 1170, network interface 1180, an input interface 1190. All the components except display unit 1170 may communicate with each other over communication path 1150, which may contain several buses as is well known in the relevant arts. The components of FIG. 11 are described below in further detail.

CPU 1110 may execute instructions stored in RAM 1120 to provide several features of the present disclosure. CPU 1110 may contain multiple processing units, with each processing unit potentially being designed for a specific task. Alternatively, CPU 1110 may contain only a single general-purpose processing unit.

RAM 1120 may receive instructions from secondary memory 1130 using communication path 1150. RAM 1120 is shown currently containing software instructions, such as those used in threads and stacks, constituting shared environment 1125 and/or user programs 1126. Shared environment 1125 includes operating systems, device drivers, virtual machines, etc., which provide a (common) run time environment for execution of user programs 1126.

Graphics controller 1160 generates display signals (e.g., in RGB format) to display unit 1170 based on data/instructions received from CPU 1110. Display unit 1170 contains a display screen to display the images defined by the display signals. Input interface 1190 may correspond to a keyboard and a pointing device (e.g., touch-pad, mouse) and may be used to provide inputs. Network interface 1180 provides connectivity to a network (e.g., using Internet Protocol), and may be used to communicate with other systems (such as those shown in FIG. 1, network 104) connected to the network.

Secondary memory 1130 may contain hard drive 1135, flash memory 1136, and removable storage drive 1137. Secondary memory 1130 may store the data software instructions (e.g., for performing the actions noted above with respect to the Figures), which enable digital processing system 1100 to provide several features in accordance with the present disclosure.

Some or all of the data and instructions may be provided on the removable storage unit 1140, and the data and instructions may be read and provided by removable storage drive 1137 to CPU 1110. Floppy drive, magnetic tape drive, CD-ROM drive, DVD Drive, Flash memory, a removable memory chip (PCMCIA Card, EEPROM) are examples of such removable storage drive 1137.

The removable storage unit 1140 may be implemented using medium and storage format compatible with removable storage drive 1137 such that removable storage drive 1137 can read the data and instructions. Thus, removable storage unit 1140 includes a computer readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 1140 or hard disk installed in hard drive 1135. These computer program products are means for providing software to digital processing system 1100. CPU 1110 may retrieve the software instructions and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1130. Volatile media includes dynamic memory, such as RAM 1120. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1150. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus, the scope of the present disclosure is defined by the appended claims and includes both combinations and sub-combinations of the various features described hereinabove as well as variations and modifications thereof, which would occur to persons skilled in the art upon reading the foregoing description.

1. A method for trading an asset on a trade facilitating platform, comprising:
dividing an asset listed for trading by an owner into a plurality of segments ranging from a low-level risk investment segment to a high-level risk investment segment in a gradually varying risk investment level, whereby the plurality of segments of the asset tagged with a plurality of digital currencies ranging from a low-level risk to a high-level risk in a gradually varying risk level, whereby the low-level risk investment segment tagged with a low-level risk digital currency and the high-level risk investment segment tagged with a high-level risk digital currency;
listing the plurality of digital currencies tagged with the asset by the owner for enabling a plurality of investors to purchase at least one digital currency among the plurality of digital currencies tagged with a face value, whereby the plurality of investors enabled to view the risk-level associated with the plurality of digital currencies for purchasing the at least one digital currency; and
transferring an ownership of the asset listed for trading to the plurality of investors without possession of the digital asset for enabling the plurality of investors to further trade the purchased plurality of digital currencies.

2. The method of claim 1, comprising a step of enabling the owner to list the asset for trading and define an asking price.

3. The method of claim 1, whereby a count of the plurality of segments of the asset is equal to the count of the plurality of digital currencies tagged with the asset and the count of the plurality of segments of the asset are higher and/or lower to the variable count of the plurality of digital currencies tagged with the asset.

4. The method of claim 1, wherein the face value of each digital currency among the plurality of digital currencies is defined (a) by dividing the asking price with the plurality of digital currencies tagged with the asset, (b) based on a predetermined chart.

5. The method of claim 1, comprising a step of facilitating an exchange of the plurality of digital currencies tagged with the face value of one asset with other plurality of digital currencies tagged with the face value of another asset.

6. The method of claim 5, wherein the exchange of the plurality of digital currencies is defined (a) by dividing the count of the plurality of digital currencies tagged with the face value of one asset required to exchange with other plurality of digital currencies tagged with the face value of another asset, (b) based on the predetermined chart.

7. The method of claim 1, wherein the plurality of digital currencies further comprising a plurality of non-asset tagged digital currencies.

8. The method of claim 7, comprising a step of enabling the exchange of the plurality of digital currencies tagged with the plurality of segments of the asset with the plurality of non-asset tagged digital currencies.

9. The method of claim 1, further comprising a step of enabling the owner to list goods and services offered for trading using the plurality of digital currencies.

10. The method of claim 1, further comprising a step of associating the asset related information to the plurality of digital currencies tagged with the plurality of segments of the asset.

11. A method for trading an asset on a trade facilitating platform, comprising:
enabling an owner to list an asset for trading at an asking price;
determining a PEG price for the asset, whereby the PEG price comprising a value higher than the asking price; and a value lower than the asking price; whereby the PEG price for the asset configured to be dynamically changing in response to a predetermined chart;
providing a first type of investment option, whereby the first type of investment option comprising a step of enabling a single investor among the plurality of investors for possessing the asset by purchasing for a price lower than the PEG price; a price equal the PEG price; a price greater than PEG price; a price lower than the asking price; a price equal to the asking price; and a price higher than the asking price;
providing a second type of investment option, whereby the second type of investment option comprises a step of enabling the single investor among the plurality of investors to purchase the asset without possession for the price lower than the PEG price; the price equal the PEG price; the price greater than PEG price; the price lower than the asking price; the price equal to the asking price; and the price higher than the asking price; and further list the purchased asset for trading;
providing a third type of investment option, whereby the third type of investment option comprising a step of enabling the plurality of investors to buy a plurality of digital currencies ranging from a low-level risk to high-level risk in a gradually varying risk level which are tagged to a plurality of segments divided from the asset, whereby the plurality of segments of the asset range from a low-level risk investment segment to a high-level risk investment segment in a gradually varying risk investment level, whereby low-level risk investment segment tagged with a low-level risk digital currency and high-level risk investment segment tagged with a high-level risk digital currency; and
implementing a block-chain driven authentication on a trading transaction executed between the owner and/or a plurality of owners and the plurality of investors and further recording a plurality of credentials of the trading transaction.

12. The method of claim 11, wherein the PEG price further comprising a static value.

13. The method of claim 11, further comprising a step of selling the asset at the negotiation of the asking price and the PEG price.

14. The method of claim 11, further comprising a step of enabling an exchange of asset from a first category with the asset from a second category for the price lower than the PEG price of the asset from first category; the price equal the PEG price of the asset from the first category; the price greater than PEG price of the asset from the first category; the price lower than the asking price of the asset from the first category; the price equal to the asking price of the asset from the first category; and a price higher than the asking price of the asset from the first category; the price lower than the PEG price of the asset from the second category; the price equal the PEG price of the asset from the second category; the price greater than PEG price of the asset from the second category; the price lower than the asking price of the asset from the second category; the price equal to the asking price of the asset from the second category; and a price higher than the asking price of the asset from the second category.

15. The method of claim 11, further comprising a step of enabling the owner to sell the digital asset in exchange for the plurality of digital currencies for the price lower than the PEG price; the price equal the PEG price; the price greater than the PEG price; the price lower than the asking price; the price equal to the asking price; and a price higher than the asking price; and further list the purchased asset for trading.

16. The method of claim 11, further comprising a step of enabling a step of trading of the plurality of digital currencies.

17. The method of claim 16, wherein the step of trading the plurality of digital currencies further comprising a step of transferring the plurality of digital currencies which are represented by visually differentiating pattern.

18. The method of claim 11, further comprising:
offering a plurality of assets for selling at the asking price and the PEG price by the owner to the investor;
allowing the plurality of assets from the first category in exchange for the plurality of assets from the second category by the investor with the owner; and
accepting and rejecting the investor's exchange by the owner.

19. The method of claim 18, further comprising a step of allowing a negotiation of the asking price or the PEG price by the investor with the owner.

20. The method of claim 11, further comprising a step of bidding for the asset on a fractional ownership basis by the plurality of investors.

21. A system for trading an asset, comprising:
a trade facilitating platform comprising:
an asset listing unit configured for enabling an owner to list an asset and dividing the asset listed for trading into a plurality of segments ranging from a low-level risk investment segment to a high-level risk investment segment in a varying risk investment level;
an asset tagging unit for dynamically tagging a plurality of segments with a plurality of digital currencies ranging from a low-level risk to a high-level risk in a gradually varying risk level, whereby the low-level risk investment segment tagged with a low-level risk digital currency and the high-level risk investment segment tagged with a high-level risk digital currency;
an asset trading unit for enabling the owner to list the plurality of digital currencies tagged with the asset for trading and for enabling a plurality of investors to purchase at least one digital currency among the plurality of digital currencies tagged with a face value, whereby the plurality of investors enabled to view the risk-level associated with the plurality of digital currencies for purchasing the at least one digital currency; and
a transaction recording unit configured for authenticating a trading transaction executed between an owner and the plurality of investors and further recording a plurality of credentials of the trading transaction.

22. The system of claim 21, wherein the asset comprising at least one of:
an interchangeable asset;
a non-interchangeable asset;
goods listed for trading;
services offered; and
a complex asset which is the combination of the interchangeable asset;
and a non-interchangeable asset; and a mark-up asset.

23. The system of claim 21, further comprising an escrow account unit configured for enabling the owner to deposit a predetermined reserve currency for listing the asset in the asset listing unit.

24. The system of claim 23, wherein the escrow account unit further configured for enabling the plurality of investors to deposit a predetermined reserve currency for trading the digital currencies listed for trading.

25. The system of claim 21, wherein the trade facilitating platform configured to exchange the plurality of digital currencies tagged with the plurality of segments of the asset with the plurality of goods and services.
